(19) United States
(12) Patent Application Publication
(10) Pub. No.: US 2006/0031071 A1
(43) Pub. Date: Feb. 9, 2006

(54) System and method for automatically implementing a finite state automaton for speech recognition

(75) Inventors: Gustavo Abrego, San Jose, CA (US); Atsuo Hiroe, Yokohama-shi (JP); Eugene J. Koontz, Mountain View, CA (US)

Correspondence Address: Gregory J. Koerner;Redwood Patent Law, 1291 East Hillsdale Boulevard, Suite 205, Foster City, CA, 94404, US

(73) Assignees: Sony Corporation; Sony Electronics Inc.

(21) Appl. No.: 10/909,997

(22) Filed: Aug. 3, 2004

(51) Int. Cl. G10L 15/14

(52) U.S. Cl. 704/256

(57) ABSTRACT

A system and method for automatically implementing a finite state automaton for speech recognition includes a finite state automaton generator that analyzes one or more input text sequences and automatically creates a node table and a link table to define the finite state automaton. The node table includes N-tuples from the input text sequences. Each N-tuple includes a current word and a corresponding history of one or more prior words from the input text sequences. The node table also includes unique node identifiers that each correspond to a different respective one of the current words. The link table includes specific links between successive words from the input text sequences. The links identified in the link table are defined by utilizing start node identifiers and end node identifiers from the unique node identifiers of the node table.

### BACKGROUND SECTION

1. Field of Invention

This invention relates generally to electronic speech recognition systems, and relates more particularly to a system and method for automatically implementing a finite state automaton for speech recognition.

2. Description of the Background Art

Implementing robust and effective techniques for system users to interface with electronic devices is a significant consideration of system designers and manufacturers. Voice-controlled operation of electronic devices may often provide a desirable interface for system users to control and interact with electronic devices. For example, voice-controlled operation of an electronic device may allow a user to perform other tasks simultaneously, or can be advantageous in certain types of operating environments. In addition, hands-free operation of electronic devices may also be desirable for users who have physical limitations or other special requirements.

Hands-free operation of electronic devices may be implemented by various speech-activated electronic devices. Speech-activated electronic devices advantageously allow users to interface with electronic devices in situations where it would be inconvenient or potentially hazardous to utilize a traditional input device. However, effectively implementing such speech recognition systems creates substantial challenges for system designers.

For example, enhanced demands for increased system functionality and performance require more system processing power and require additional hardware resources. An increase in processing or hardware requirements typically results in a corresponding detrimental economic impact due to increased production costs and operational inefficiencies.

Furthermore, enhanced system capability to perform various advanced operations provides additional benefits to a system user, but may also place increased demands on the control and management of various system components. Therefore, for at least the foregoing reasons, implementing a robust and effective method for a system user to interface with electronic devices through speech recognition remains a significant consideration of system designers and manufacturers.

### SUMMARY

In accordance with the present invention, a system and method are disclosed for automatically implementing a finite state automaton (FSA) for speech recognition. In one embodiment, one or more input text sequences are initially provided to an FSA generator by utilizing any effective techniques. A tuple-length variable value may then be selectively defined for producing N-tuples that have a total of “N” words. Next, the FSA generator automatically generates a series of all N-tuples that are represented in the input text sequences.

The FSA generator filters the foregoing N-tuples for redundancy to thereby produce a set of unique N-tuples corresponding to the input text sequences. The FSA generator then automatically assigns unique node identifiers to current words from the foregoing N-tuples. Finally, the FSA generator stores a node table including the N-tuples and the node identifiers into a memory of a host electronic device. A speech recognition engine may then access the node table for defining individual nodes of a finite state automaton for performing speech recognition procedures.

The same original input text sequences that were utilized to create the foregoing node table are also accessed by the FSA generator to create a corresponding link table. Initially, the FSA generator substitutes node identifiers from the node table for corresponding words from the input text sequences to thereby produce one or more corresponding node identifier sequences. Then, the FSA generator automatically identifies a series of links between adjacent word pairs in the input text sequences by utilizing the substituted node identifiers from the node identifier sequences. In certain embodiments, the FSA generator may also calculate transition probability values for the identified links.

The FSA generator filters the foregoing links for redundancy to thereby produce a set of unique links corresponding to sequential pairs of words from the input text sequences. Next, the FSA generator assigns unique link identifiers to the identified links. Finally, the FSA generator stores the resulting link table in a memory of the host electronic device. The speech recognition engine may then access the link table for defining individual links connecting pairs of nodes in a finite state automaton used for performing various speech recognition procedures. The present invention therefore provides an improved system and method for automatically implementing a finite state automaton for speech recognition.

### BRIEF DESCRIPTION OF THE DRAWINGS

FIG. 1 is a block diagram for one embodiment of an electronic device, in accordance with the present invention;

FIG. 2 is a block diagram for one embodiment of the memory of FIG. 1, in accordance with the present invention;

FIG. 3 is a block diagram for one embodiment of the speech recognition engine of FIG. 2, in accordance with the present invention;

FIG. 4 is a block diagram illustrating functionality of the speech recognition engine of FIG. 3, in accordance with one embodiment of the present invention;

FIG. 5 is a diagram illustrating an exemplary finite state automaton of FIG. 3, in accordance with one embodiment of the present invention;

FIG. 6 is a block diagram for an N-tuple, in accordance with one embodiment of the present invention;

FIG. 7 is a block diagram for the node table of FIG. 2, in accordance with one embodiment of the present invention;

FIG. 8 is a block diagram for a link, in accordance with one embodiment of the present invention;

FIG. 9 is a block diagram for the link table of FIG. 2, in accordance with one embodiment of the present invention;

FIG. 10 is a flowchart of method steps for creating a node table, in accordance with one embodiment of the present invention; and

FIG. 11 is a flowchart of method steps for creating a link table, in accordance with one embodiment of the present invention.

### DETAILED DESCRIPTION

The present invention relates to an improvement in speech recognition systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for automatically implementing a finite state automaton for speech recognition, and includes a finite state automaton generator that analyzes one or more input text sequences. The finite state automaton generator automatically creates a node table and a link table that may be utilized to define the finite state automaton. The node table includes N-tuples from the input text sequences. Each N-tuple includes a current word and a corresponding history of one or more prior words from the input text sequences. The node table also includes unique node identifiers that each correspond to a different respective one of the current words. The link table includes specific links between successive words from the input text sequences. The links identified in the link table are defined by utilizing start node identifiers and end node identifiers from the unique node identifiers of the node table.

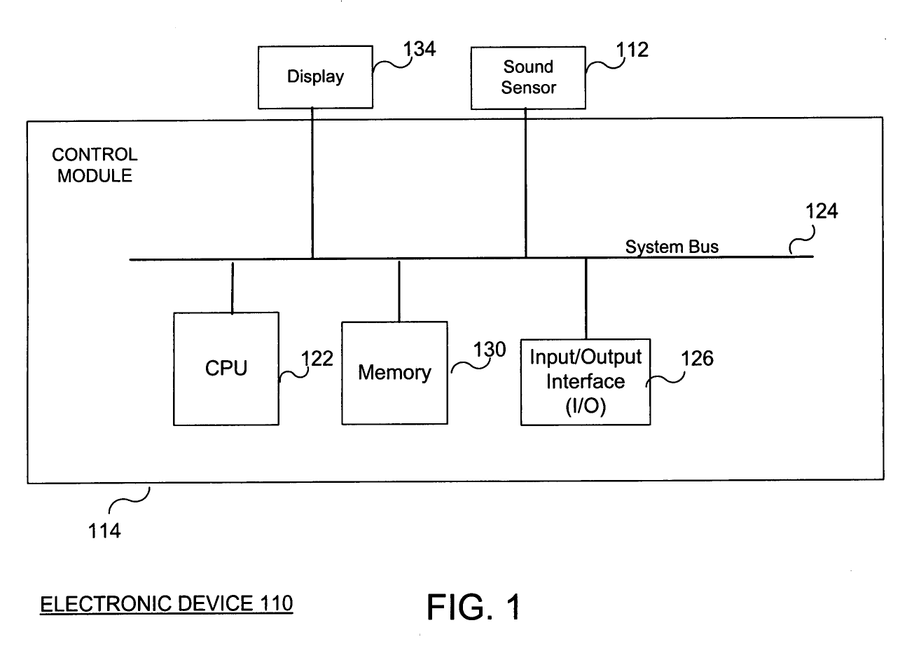

Referring now to FIG. 1, a block diagram for one embodiment of an electronic device 110 is shown, according to the present invention. The FIG. 1 embodiment includes, but is not limited to, a sound sensor 112, a control module 114, and a display 134. In alternate embodiments, electronic device 110 may readily include various other elements or functionalities in addition to, or instead of, certain elements or functionalities discussed in conjunction with the FIG. 1 embodiment.

In accordance with certain embodiments of the present invention, electronic device 110 may be embodied as any appropriate electronic device or system. For example, in certain embodiments, electronic device 110 may be implemented as a computer device, a personal digital assistant (PDA), a cellular telephone, a television, a game console, and as part of entertainment robots such as AIBO™ and QRIO™ by Sony Corporation.

In the FIG. 1 embodiment, electronic device 110 utilizes sound sensor 112 to detect and convert ambient sound energy into corresponding audio data. The captured audio data is then transferred over system bus 124 to CPU 122, which responsively performs various processes and functions with the captured audio data, in accordance with the present invention.

In the FIG. 1 embodiment, control module 114 includes, but is not limited to, a central processing unit (CPU) 122, a memory 130, and one or more input/output interface(s) (I/O) 126. Display 134, CPU 122, memory 130, and I/O 126 are each coupled to, and communicate, via common system bus 124. In alternate embodiments, control module 114 may readily include various other components in addition to, or instead of, those components discussed in conjunction with the FIG. 1 embodiment.

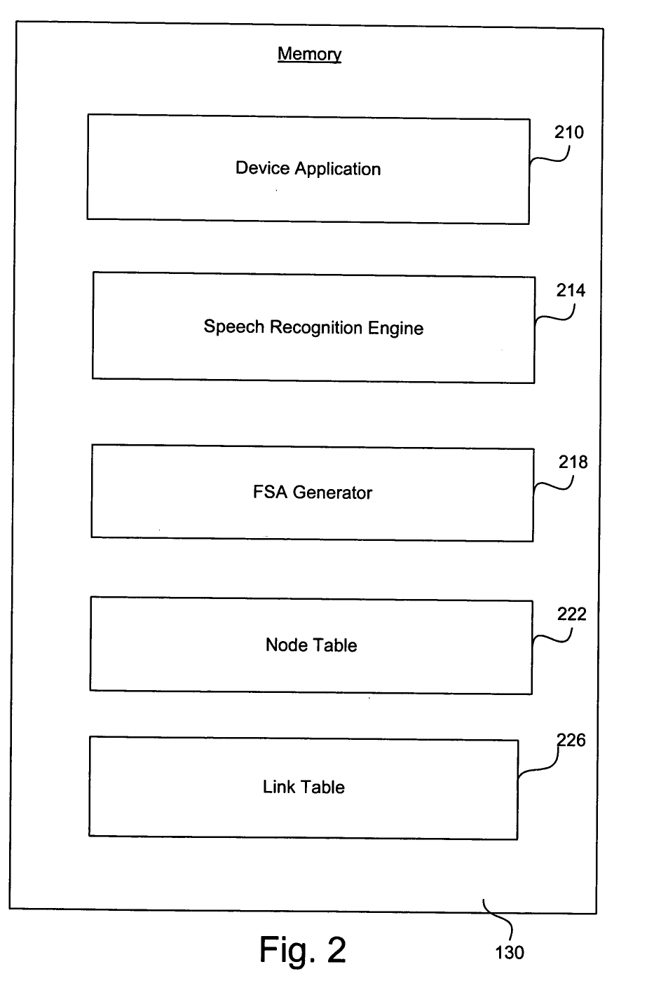

In the FIG. 1 embodiment, CPU 122 is implemented to include any appropriate microprocessor device. Alternately, CPU 122 may be implemented using any other appropriate technology. For example, CPU 122 may be implemented as an application-specific integrated circuit (ASIC) or other appropriate electronic device. In the FIG. 1 embodiment, I/O 126 provides one or more effective interfaces for facilitating bi-directional communications between electronic device 110 and any external entity, including a system user or another electronic device. I/O 126 may be implemented using any appropriate input and/or output devices. The functionality and utilization of electronic device 110 are further discussed below in conjunction with FIG. 2 through FIG. 11.

Referring now to FIG. 2, a block diagram for one embodiment of the FIG. 1 memory 130 is shown, according to the present invention. Memory 130 may comprise any desired storage-device configurations, including, but not limited to, random access memory (RAM), read-only memory (ROM), and storage devices such as floppy discs or hard disc drives. In the FIG. 2 embodiment, memory 130 stores a device application 210, speech recognition engine 214, a finite state automaton (FSA) generator 218, a node table 222, and a link table 226. In alternate embodiments, memory 130 may readily include store other elements or functionalities in addition to, or instead of, certain elements or functionalities discussed in conjunction with the FIG. 2 embodiment.

In the FIG. 2 embodiment, device application 210 includes program instructions that are preferably executed by CPU 122 (FIG. 1) to perform various functions and operations for electronic device 110. The particular nature and functionality of device application 210 typically varies depending upon factors such as the type and particular use of the corresponding electronic device 110.

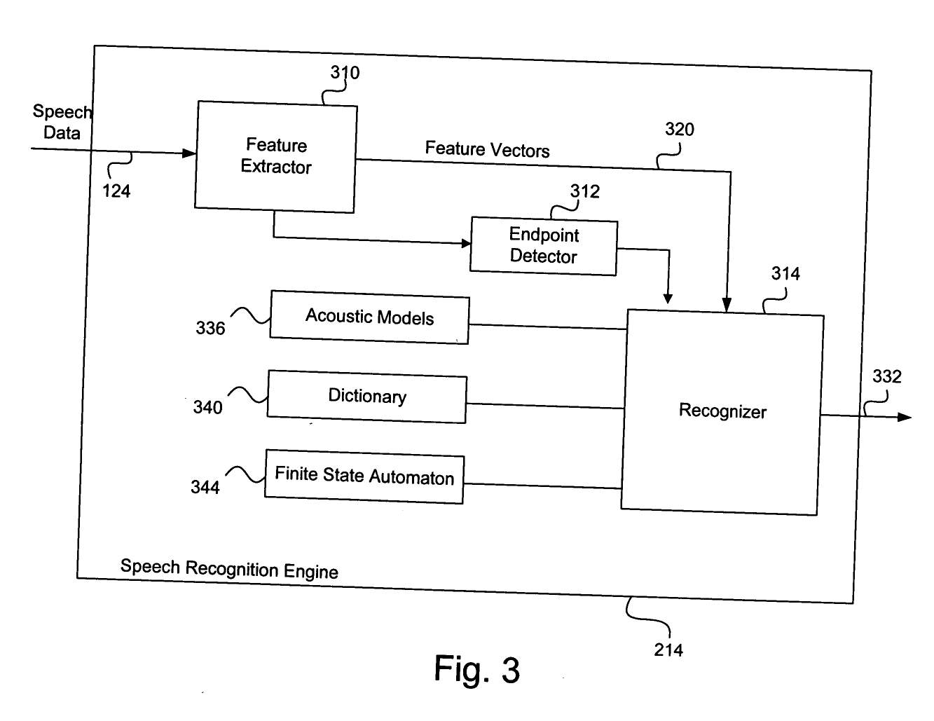

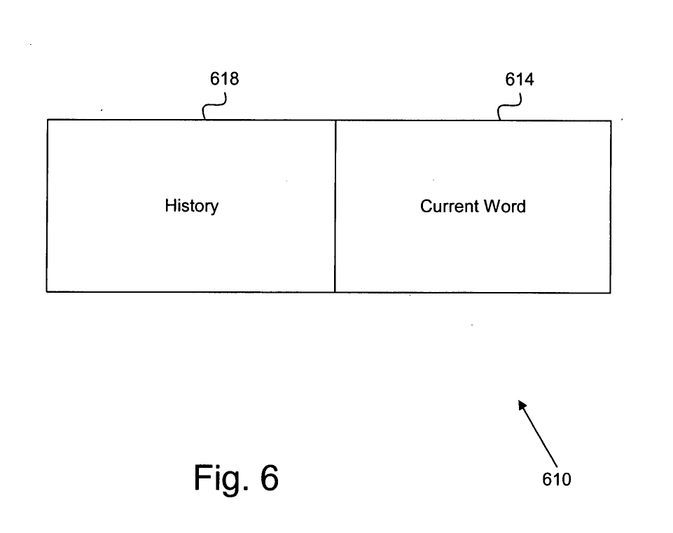

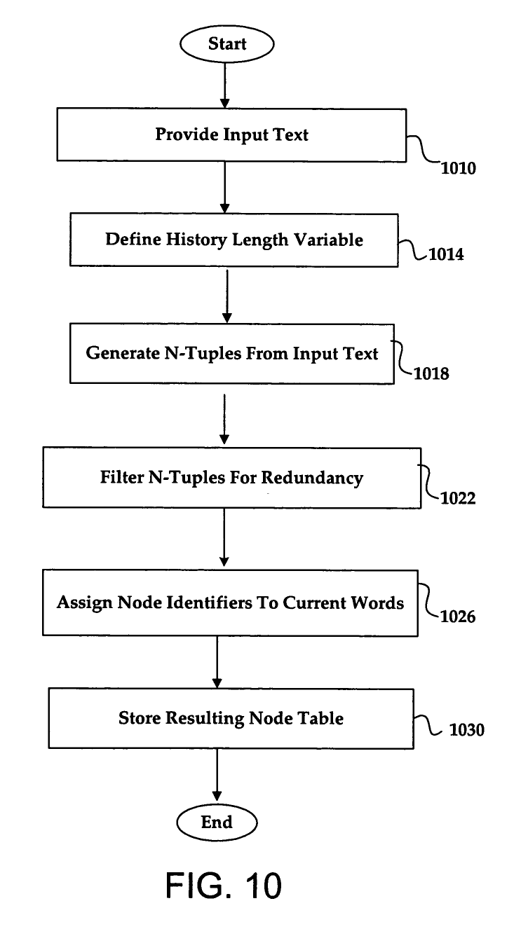

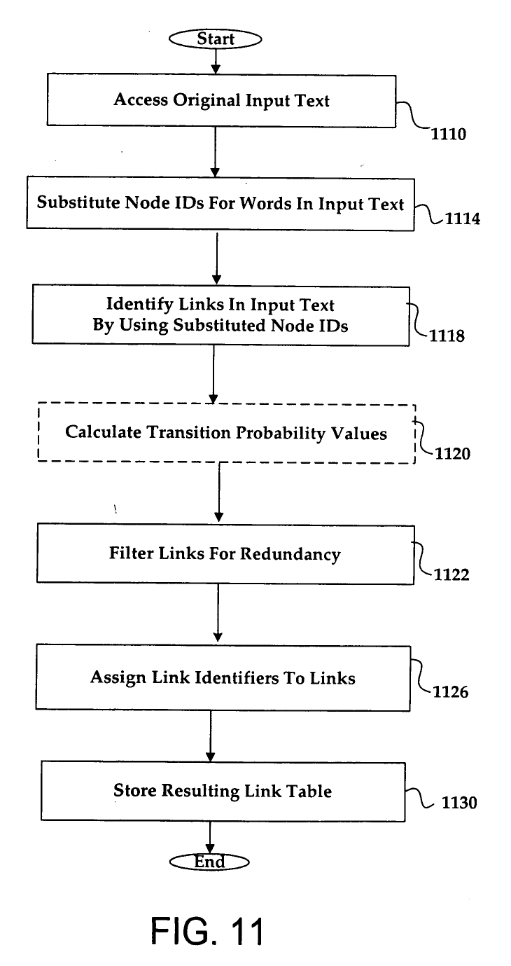

In the FIG. 2 embodiment, speech recognition engine 214 includes one or more software modules that are executed by CPU 122 to analyze and recognize input sound data. Certain embodiments of speech recognition engine 214 are further discussed below in conjunction with FIGS. 3-5. In the FIG. 2 embodiment, FSA generator 218 includes one or more software modules and other information for creating node table 222 and link table 226 to thereby define a finite state automaton (FSA) for use in various speech recognition procedures. The implementation and utilization of node table 222 and link table 226 are further discussed below in conjunction with FIGS. 6-11. In addition, the utilization and functionality of FSA generator 218 is further discussed below in conjunction with FIGS. 10-11.

Referring now to FIG. 3, a block diagram for one embodiment of the FIG. 2 speech recognition engine 214 is shown, in accordance with the present invention. Speech recognition engine 214 includes, but is not limited to, a feature extractor 310, an endpoint detector 312, a recognizer 314, acoustic models 336, dictionary 340, and a finite state automaton 344. In alternate embodiments, speech recognition engine 214 may readily include various other elements or functionalities in addition to, or instead of, certain elements or functionalities discussed in conjunction with the FIG. 3 embodiment.

In the FIG. 3 embodiment, sound sensor 112 (FIG. 1) provides digital speech data to feature extractor 310 via system bus 124. Feature extractor 310 responsively generates corresponding representative feature vectors, which may be provided to recognizer 314 via path 320. Feature extractor 310 may further provide the speech data to endpoint detector 312, and endpoint detector 312 may responsively identify endpoints of utterances represented by the speech data to indicate the beginning and end of an utterance in time. Endpoint detector 312 may then provide the endpoints to recognizer 314.

In the FIG. 3 embodiment, recognizer 314 is configured to recognize words in a vocabulary which is represented in dictionary 340. The foregoing vocabulary in dictionary 340 corresponds to any desired sentences, word sequences, commands, instructions, narration, or other audible sounds that are supported for speech recognition by speech recognition engine 214.

In practice, each word from dictionary 340 is associated with a corresponding phone string (string of individual phones) which represents the pronunciation of that word. Acoustic models 336 (such as Hidden Markov Models) for each of the phones are selected and combined to create the foregoing phone strings for accurately representing pronunciations of words in dictionary 340. Recognizer 314 compares input feature vectors from line 320 with the entries (phone strings) from dictionary 340 to determine which word produces the highest recognition score. The word corresponding to the highest recognition score may thus be identified as the recognized word.

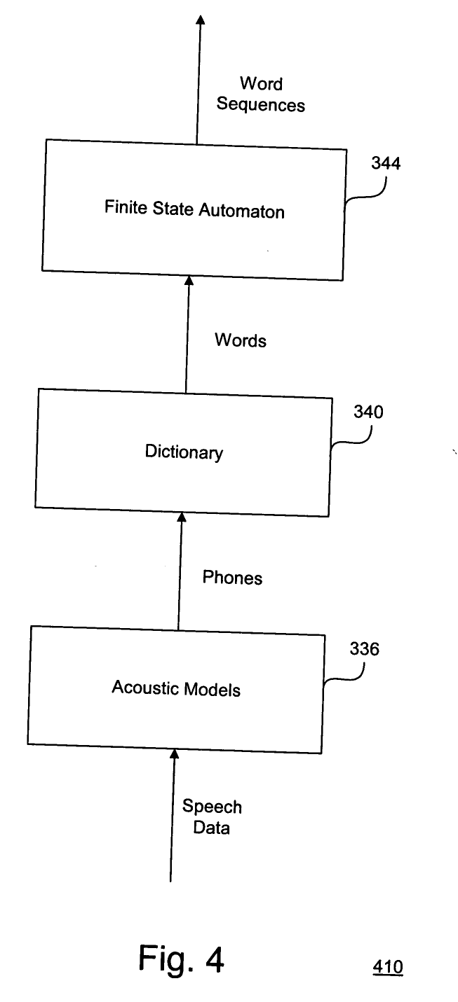

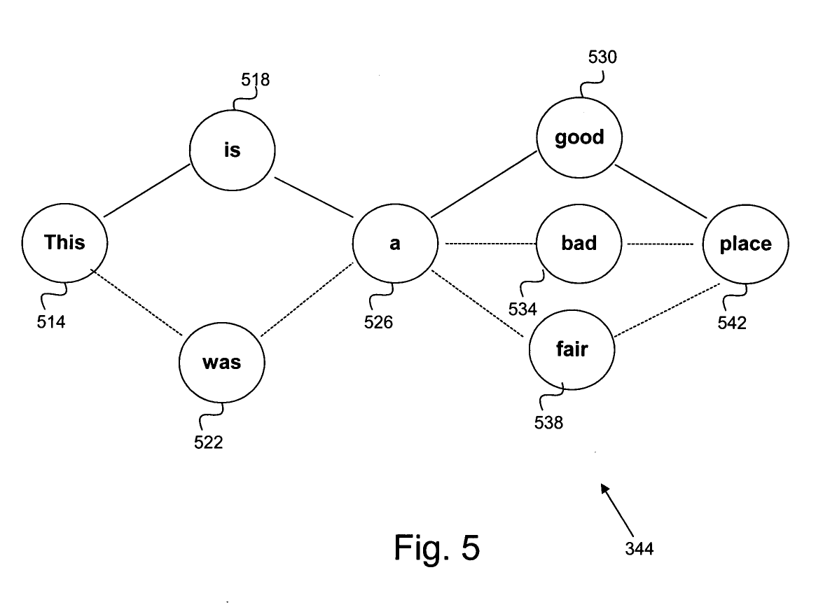

Speech recognition engine 214 also utilizes finite state automaton 344 as a recognition grammar to determine specific recognized word sequences that are supported by speech recognition engine 214. The recognized sequences of vocabulary words may then be output as recognition results from recognizer 314 via path 332. The operation and implementation of recognizer 314, dictionary 340, and finite state automaton 344 are further discussed below in conjunction with FIGS. 4-5.

Referring now to FIG. 4, a block diagram illustrating functionality of the FIG. 3 speech recognition engine 214 is shown, in accordance with one embodiment of the present invention. In alternate embodiments, the present invention may readily perform speech recognition procedures using various techniques or functionalities in addition to, or instead of, certain techniques or functionalities discussed in conjunction with the FIG. 4 embodiment.

In the FIG. 4 embodiment, speech recognition engine 214 receives speech data from sound sensor 112, as discussed above in conjunction with FIG. 3. Recognizer 314 (FIG. 3) from speech recognition engine 214 compares the input speech data with acoustic models 336 to identify a series of phones (phone strings) that represent the input speech data. Recognizer 314 references dictionary 340 to look up recognized vocabulary words that correspond to the identified phone strings. The recognizer 314 then utilizes finite state automaton 344 as a recognition grammar to form the recognized vocabulary words into word sequences, such as sentences, phrases, commands, or narration, which are supported by speech recognition engine 214. Various techniques for automatically implementing FSA 344 are further discussed below in conjunction with FIGS. 5-11.

Referring now to FIG. 5, a diagram illustrating an exemplary finite state automaton (FSA) 344 from FIG. 3 is shown, in accordance with one embodiment of the present invention. The FIG. 5 embodiment is presented for purposes of illustration, and in alternate embodiments, the present invention may generate finite state automatons with various configurations, elements, or functionalities in addition to, or instead of, certain configurations, elements, or functionalities discussed in conjunction with the FIG. 5 embodiment. For example, the present invention may readily generate finite state automatons with various other words/nodes, links, and node sequences.

In the FIG. 5 embodiment, FSA 344 includes a network of words/nodes 514, 518, 522, 526, 530, 534, 538, and 542 and associated links that collectively represent various possible sequences of words that are supported for recognition by speech recognition engine 214. FSA 344 may therefore function as a recognition grammar for speech recognition engine 214. Each word/node represents a single vocabulary word from dictionary 340 (FIG. 3), and the supported word sequences are arranged in time, from left to right in FIG. 5, with initial words being located on the left side of FIG. 5, and final words being located on the right side of FIG. 5. Each of the words/nodes in FSA 344 is connected to one or more other words/nodes in FSA 344 by links.

In the FIG. 5 example, recognizer 314 may utilize dictionary 340 to generate the vocabulary words “This is a good place.” In response, FSA 344 identifies corresponding words/nodes 514, 518, 526, 530, and 542 (This is a good place) as being a word sequence that is supported by speech recognition engine 214. Recognizer 314 therefore outputs the foregoing word sequence as a recognition result for utilization by electronic device 110.

In certain situations, through the utilization of a compact dictionary 340 with a limited number of vocabulary words, and a corresponding pre-defined FSA 344 that prescribes only a limited number of supported word sequences, speech recognition engine 214 may therefore be implemented with an economical and simplified design that conserves system resources such as processing requirements, memory capacity, and communication bandwidth.

Referring now to FIG. 6, a block diagram for one embodiment of an N-tuple 610 is shown, according to the present invention. The FIG. 6 embodiment includes, but is not limited to, a current word 614 and a history 618. In alternate embodiments, N-tuple 610 may readily include various other elements or functionalities in addition to, or instead of, certain elements or functionalities discussed in conjunction with the FIG. 6 embodiment.

In according with the present invention, N-tuple 610 includes a consecutive sequence of “N” words automatically identified by FSA generator 218 from one or more input text sequences provided to electronic device 110 in any effective manner. In certain embodiments, input text sequences may be provided by utilizing a tokenization technique that transforms the input sentences into a series of tokens (words) that are used in later steps. Besides using plain sentences in an explicit way as input text, the system user may also be allowed to use a special notation to show alternations between words, grouping, and variable substitution.

This tokenization adds more flexibility to the application design process. These options allow the system user to declare sentences implicitly. For instance, if the input text has the following line “I am a good (boy|girl)”, the tokenizer should be able to unwrap the implicit sentences which in this case are: “I am a good boy” and “I am a good girl”. Moreover, the use of variables would allow even more flexible usage. If a variable is defined as “$who=(boy|girl)”, then this variable can be later used to represent input text such as “you are a bad $who”. The notation given in this explanation is an example, and the actual notation used to use to denote word alternation, expansion, and variable substitution may readily be different.

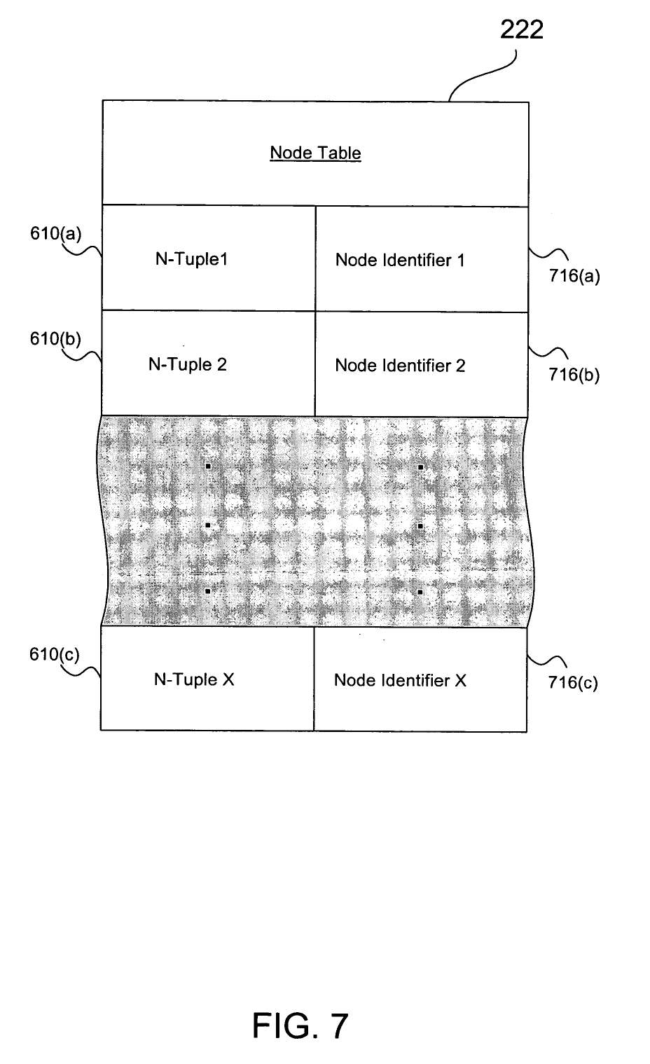

In the FIG. 6 embodiment, the N-tuple length “N” is a variable value that may be selected according to various design considerations. For example, a 2-tuple would include a sequence of two consecutive words from the foregoing input text sequence(s) that are supported for speech recognition by speech recognition engine 214. An N-tuple 610 may therefore be described as a current word 614 preceded by a history 618 of one or more consecutive history words from the input text sequences. However, in certain instances, such as at the beginning of a sentence, history 618 may include one or more nulls. In accordance with the present invention, current words 614 of the N-tuples 610 (identified from the input text) correspond to nodes of FSA 344 (see FIG. 5). The identification and utilization of N-tuples 610 are further discussed below in conjunction with FIGS. 7-11.

Referring now to FIG. 7, a block diagram for one embodiment of the FIG. 2 node table 222 is shown, in accordance with the present invention. In alternate embodiments, node table 222 may readily include various other elements or functionalities in addition to, or instead of, certain elements or functionalities discussed in conjunction with the FIG. 7 embodiment.

In the FIG. 7 embodiment, node table 222 includes an N-tuple 1 (610(a)) through an N-tuple X (610(c)). Node table 222 may be implemented to include any desired number of N-tuples 610 that may include any desired type of information. In accordance with the present invention, FSA generator 218 automatically analyzes input text sequences to identify possible unique N-tuples 610 for inclusion in node table 222. In the FIG. 7 embodiment, the current word 614 (FIG. 6) from each N-tuple 610 corresponds with a unique node identifier (node ID) 716.

For example, N-tuple 1 (610(a)) corresponds to node identifier 1 (716(a)), N-tuple 2 (610(b)) corresponds to node identifier 2 (716(b)), and N-tuple X (610(c)) corresponds to node identifier X (716(c)). The foregoing node identifiers 716 may be implemented in any effective manner. In the FIG. 7 embodiment, node identifiers 716 are implemented as different unique numbers. In the FIG. 7 embodiment, different N-tuples 610 may have the same current word 614, but may be assigned different node identifiers 716 because they have different histories 618.

The node identifiers 716 therefore incorporate context information (history 618) for the corresponding current words 614 or nodes of FSA 344. In accordance with the present invention, speech recognition engine 214 (FIG. 3) may therefore reference node table 222 to accurately define the individual nodes of FSA 344 (FIG. 3) for performing various speech recognition procedures. In certain embodiments, the present invention may generate an FSA 344 that supports recognition of certain sentences and text sequences that are not present in the input text sequences. In accordance with the present invention, such sentence over-generation may effectively be reduced by increasing the value of “N” in N-tuple 610 to provide a longer history 618. The creation and utilization of node table 222 is further discussed below in conjunction with FIG. 10.

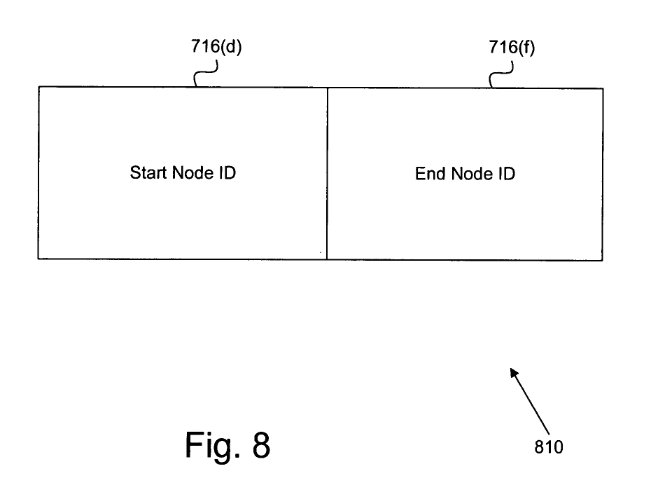

Referring now to FIG. 8, a block diagram for one embodiment of a link 810 is shown, according to the present invention. The FIG. 8 embodiment includes, but is not limited to, a start node identifier (ID) 716(d) and an end node identifier (ID) 716(f). In alternate embodiments, link 810 may readily include various other elements or functionalities in addition to, or instead of, certain elements or functionalities discussed in conjunction with the FIG. 8 embodiment.

In the FIG. 8 embodiment, FSA generator 218 initially accesses the same original input text sequence(s) that were used to create the node table 222 discussed above in conjunction with FIG. 7. FSA generator 218 associates words in the input text with corresponding identical current words 614 and histories 618 from the N-tuples 610 of node table 222. FSA generator 218 then substitutes the node identifiers 716 of the current words 614 for the associated words in the input text to thereby produce one or more corresponding node identifier sequences.

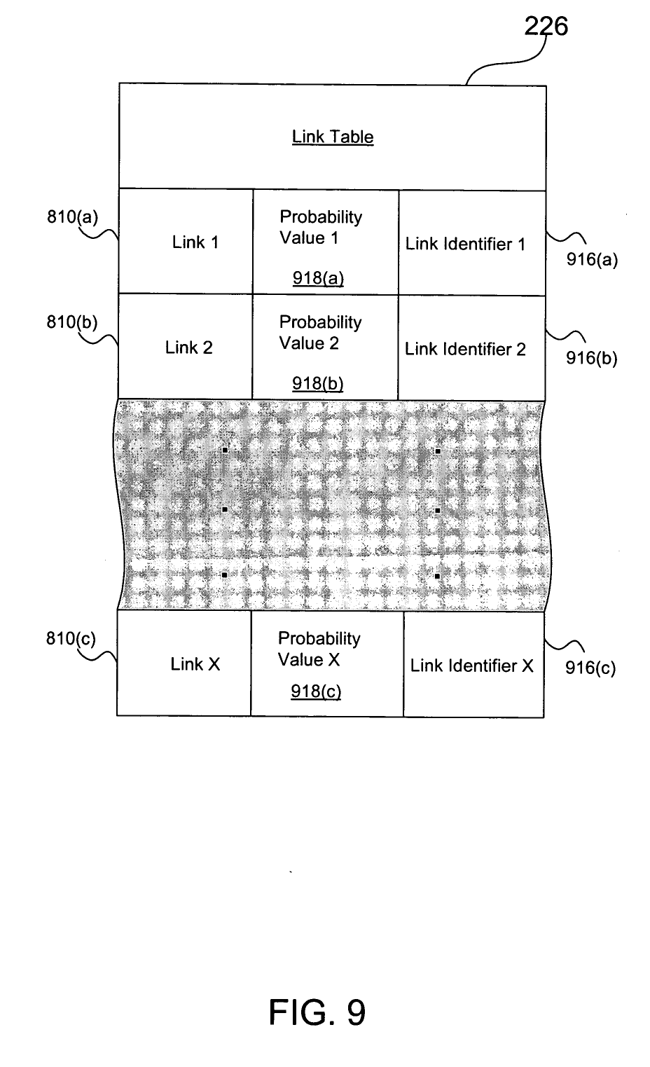

In accordance with the present invention, FSA generator 218 may then automatically identify all unique links 810 that are present in the foregoing node identifier sequences. The foregoing links 810 may be identified as any unique pair of immediately adjacent node identifiers 716 from the node identifier sequences. In the FIG. 8 embodiment, each link 810 is defined by a start node identifier (ID) 716(d) corresponding to a starting node of the link 810 from the node identifier sequences. Each link 810 is further defined by an end node identifier (ID) 716(f) corresponding to an ending node of the link 810 from the node identifier sequences. The creation and utilization of links 810 are further discussed below in conjunction with FIGS. 9 and 11.

Referring now to FIG. 9, a block diagram for one embodiment of the FIG. 2 link table 226 is shown, in accordance with the present invention. In alternate embodiments, link table 226 may readily include various other elements or functionalities in addition to, or instead of, those elements or functionalities discussed in conjunction with the FIG. 6 embodiment.

In the FIG. 9 embodiment, link table 226 includes a link 1 (810(a)) through a link X (810(c)). Link table 226 may be implemented to include any desired number of links 810 that may include any desired type of information. In accordance with the present invention, FSA generator 218 automatically analyzes the original input text sequences to identify unique links 810 for inclusion in link table 226. In addition, FSA generator 218 may assign unique link identifiers 916 to the links 810.

For example, link 1 (810(a)) corresponds to link identifier 1 (916(a)), link 2 (810(b)) corresponds to link identifier 2 (916(b)), and link X (810(c)) corresponds to link identifier X (916(c)). The foregoing link identifiers 716 may be implemented in any effective manner. In the FIG. 9 embodiment, link identifiers 916 are implemented as different unique numbers. In accordance with the present invention, speech recognition engine 214 (FIG. 3) may therefore reference link table 226 to determine the individual links 810 that connect the individual nodes 614 of node table 222, to thereby accurately and automatically define an FSA 344 (FIG. 3) for performing various speech recognition procedures.

In certain embodiments, FSA generator 218 may also associate transition probability values to the respective links 810 in link table 226. A transition probability value represents the likelihood that a start node from a given link 810 will transition to a corresponding ending node from that same given link 810. FSA generator 218 may determine the transition probability values by utilizing any appropriate techniques. For example, FSA generator 218 may analyze the original input text sequence(s), and may assign transition probability values that are proportional to the frequency that the corresponding links 810 occur in the input text sequences.

In certain embodiments, FSA generator 218 may determine a probability value for a given link 810 by analyzing link table 226 before non-unique links 810 are removed. In addition, FSA generator 226 may alternately calculate the transition probability for a given link 810 to be equal to the number of counts of the corresponding N-tuple 610 (current word 614 plus its history 618) divided by the number of counts of only the history 619 of that N-tuple 610. In one embodiment, the foregoing calculation is performed before filtering the N-tuples 610 for redundancy.

In accordance with the present invention, speech recognition engine 214 may advantageously utilize the foregoing transition probability values from link table 226 as additional information for accurately performing speech recognition procedures in difficult cases. For example, recognizer 314 may refer to appropriate transition probability values to improve the likelihood of correctly recognizing similar word sequences during speech recognition procedures. The creation and utilization of link table 226 is further discussed below in conjunction with FIG. 11.

Referring now to FIG. 10, a flowchart of method steps for creating a node table 222 is shown, in accordance with one embodiment of the present invention. The FIG. 10 flowchart is presented for purposes of illustration, and in alternate embodiments, the present invention may readily utilize various steps and sequences other than certain of those discussed in conjunction with the FIG. 10 embodiment.

In the FIG. 10 embodiment, in step 1010, one or more input text sequences that are supported by speech recognition engine 214 are provided by utilizing any effective techniques. In step 1014, a history-length variable value, N−1, is defined for producing N-tuples 610 with FSA generator 218. Then, in step 1018, FSA generator 218 automatically generates a series of all N-tuples 610 represented in the input text sequences.

In step 1022, FSA generator 218 filters the foregoing N-tuples 610 for redundancy to produce a set of unique N-tuples 610 corresponding to the input text sequences. In step 1026, FSA generator 218 assigns unique node identifiers 716 to current words 614 from the foregoing N-tuples 610. Finally, in step 1030, FSA generator 218 stores the resulting node table 222 in memory 130 of the host electronic device 110. The speech recognition engine 214 may then access node table 222 for defining individual nodes of a finite state automaton 344 (FIG. 5) for performing speech recognition procedures.

Referring now to FIG. 11, a flowchart of method steps for creating a (link table 226 is shown, in accordance with one embodiment of the present invention. The FIG. 11 flowchart is presented for purposes of illustration, and in alternate embodiments, the present invention may readily utilize various steps and sequences other than certain of those discussed in conjunction with the FIG. 11 embodiment.

In the FIG. 11 embodiment, in step 1110, the same original input text sequences that were utilized to create node table 222 in the FIG. 10 embodiment are accessed by utilizing any effective techniques. In step 1114, FSA generator 218 substitutes node identifiers 716 from node table 222 for the corresponding words in the input text sequences to produce one or more corresponding node identifier sequences.

In step 1118, FSA generator 218 automatically identifies a series of links 810 by utilizing the substituted node identifiers 716 from the foregoing node identifier sequences created in step 1114. In certain embodiments, FSA generator 218 may here calculate and assign transition probability values for the identified links 810, as discussed above in conjunction with FIG. 9.

In step 1122, FSA generator 218 filters the foregoing links 810 for redundancy to produce a set of unique links 810 corresponding to sequential pairs of words from the input text sequences. In step 1126, FSA generator 218 assigns unique link identifiers 916 to the identified links 810. Finally, in step 1130, FSA generator 218 stores the resulting link table 226 in memory 130 of the host electronic device 110. The speech recognition engine 214 may then access link table 226 for defining individual links 810 that connect pairs of nodes in a finite state automaton 344 (FIG. 5) used for performing various speech recognition procedures. The present invention therefore provides an improved system and method for automatically implementing a finite state automaton for speech recognition.

The invention has been explained above with reference to certain preferred embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A finite state automaton system, comprising:
a node table that includes tuples from one or more input text sequences, said tuples each including a current word and a history that corresponds to said current word, said node table also including node identifiers that correspond to each of said current words;
a link table that includes links between successive ones of said current words from said one or more input text sequences, each of said links being defined by a start node identifier and an end node identifier from said node identifiers; and
a finite state automaton generator that analyzes said one or more input text sequences, and creates said node table and said link table to define said finite state automaton.

2. The system of claim 1 wherein a speech recognition engine references said finite state automaton for identifying said input text sequences that are supported for speech recognition procedures in an electronic device.

3. The system of claim 1 wherein said finite state automaton includes nodes corresponding to said current words and said links that each connect a pair of said nodes for defining recognizable word sequences for speech recognition procedures.

4. The system of claim 1 wherein said node identifiers from said node table and said links from said link table define an implementation of said finite state automaton.

5. The system of claim 1 wherein said tuples are implemented as N-tuples in which a selectable value “N” defines a total number of words that form each of said tuples.

6. The system of claim 1 wherein said one or more input text sequences are provided to said finite state automaton generator by utilizing a tokenization procedure.

7. The system of claim 1 wherein a tuple length variable is initially defined to specify a total number of words in each of said tuples.

8. The system of claim 1 wherein said finite state automaton generator automatically identifies all of said tuples that are present in said one or more input text sequences.

9. The system of claim 8 wherein said finite state automaton generator filters said tuples to remove any duplicated versions of said tuples.

10. The system of claim 8 wherein said finite state automaton generator automatically assigns said node identifiers to uniquely represent said respective ones of said current words.

11. The system of claim 10 where said finite state automaton generator stores said tuples and said node identifiers as said node table.

12. The system of claim 1 wherein said finite state automaton generator accesses said one or more input text sequences for generating said link table, said one or more input text sequences being also utilized to generate said node table.

13. The system of claim 1 wherein said finite state automaton generator automatically analyzes said one or more input text sequences to substitute said node identifiers for said current words to generate node identifier sequences.

14. The system of claim 13 wherein said finite state automaton generator automatically identifies said links as successive pairs of said node identifiers from said node identifier sequences.

15. The system of claim 1 wherein said finite state automaton generator filters said links to remove any duplicated versions of said links.

16. The system of claim 1 wherein said finite state automaton generator assigns unique link identifiers to respective ones of said links.

17. The system of claim 16 wherein said finite state automaton generator stores said links and said unique link identifiers as said link table.

18. The system of claim 1 wherein a selectable tuple-length variable value “N” is increased to reduce an over-generation of recognized word sequences when using said finite state automaton in speech recognition procedures.

19. The system of claim 1 wherein said link table includes transition probability values associated with at least some of said links to indicate a likelihood of said links being correct during speech recognition procedures.

20. The system of claim 19 wherein said finite state automaton generator determines said transition probability values based upon a frequency of corresponding ones of said tuples in said one or more input text sequences.

21. A method for implementing a finite state automaton, comprising:
generating a node table that includes tuples from one or more input text sequences, said tuples each including a current word and a history that corresponds said current word, said node table also including node identifiers that correspond to each of said current words;
creating a link table that includes links between successive ones of said current words from said one or more input text sequences, each of said links being defined by a start node identifier and an end node identifier from said node identifiers; and
analyzing said one or more input text sequences with a finite state automaton generator for creating said node table and said link table to define said finite state automaton.

22. The method of claim 21 wherein a speech recognition engine references said finite state automaton for identifying said input text sequences that are supported for speech recognition procedures in an electronic device.

23. The method of claim 21 wherein said finite state automaton includes nodes corresponding to said current words and said links that each connect a pair of said nodes for defining recognizable word sequences for speech recognition procedures.

24. The method of claim 21 wherein said node identifiers from said node table and said links from said link table define an implementation of said finite state automaton.

25. The method of claim 21 wherein said tuples are implemented as N-tuples in which a selectable value “N” defines a total number of words that form each of said tuples.

26. The method of claim 21 wherein said one or more input text sequences are provided to said finite state automaton generator by utilizing a tokenization procedure.

27. The method of claim 21 wherein a tuple length variable is initially defined to specify a total number of words in each of said tuples.

28. The method of claim 21 wherein said finite state automaton generator automatically identifies all of said tuples that are present in said one or more input text sequences.

29. The method of claim 28 wherein said finite state automaton generator filters said tuples to remove any duplicated versions of said tuples.

30. The method of claim 28 wherein said finite state automaton generator automatically assigns said node identifiers to uniquely represent said respective ones of said current words.

31. The method of claim 30 where said finite state automaton generator stores said tuples and said node identifiers as said node table.

32. The method of claim 21 wherein said finite state automaton generator accesses said one or more input text sequences for generating said link table, said one or more input text sequences being also utilized to generate said node table.

33. The method of claim 21 wherein said finite state automaton generator automatically analyzes said one or more input text sequences to substitute said node identifiers for said current words to generate node identifier sequences.

34. The method of claim 33 wherein said finite state automaton generator automatically identifies said links as successive pairs of said node identifiers from said node identifier sequences.

35. The method of claim 21 wherein said finite state automaton generator filters said links to remove any duplicated versions of said links.

36. The method of claim 21 wherein said finite state automaton generator assigns unique link identifiers to respective ones of said links.

37. The method of claim 36 wherein said finite state automaton generator stores said links and said unique link identifiers as said link table.

38. The method of claim 21 wherein a selectable tuple-length variable value “N” is increased to reduce an over-generation of recognized word sequences when using said finite state automaton in speech recognition procedures.

39. The method of claim 21 wherein said link table includes transition probability values associated with at least some of said links to indicate a likelihood of said said links being correct during speech recognition procedures.

40. The method of claim 39 wherein said finite state automaton generator determines said transition probability values based upon a frequency of corresponding ones of said tuples in said one or more input text sequences.

41. A system for implementing a finite state automaton, comprising:
means for generating a node table that includes tuples from one or more input text sequences, said tuples including current words and histories that correspond to respective ones of said current words, said node table also including node identifiers that correspond to said respective ones of said current words;
means for creating a link table that includes links between successive words from said one or more input text sequences, said links being defined by start node identifiers and end node identifiers from said node identifiers; and
means for analyzing said one or more input text sequences for automatically creating said node table and said link table to thereby define said finite state automaton.

42. A system for implementing a finite state automaton, comprising:
a node table that includes tuples from one or more input text sequences, said node table also including node identifiers that correspond to said respective ones of said current words;
a link table that includes links between successive words from said one or more input text sequences; and
a finite state machine generator that automatically creates said node table and said link table to thereby define said finite state automaton.
